(19) United States
(12) Patent Application Publication
(10) Pub. No.: US 2011/0215045 A1
(43) Pub. Date: Sep. 8, 2011

(54) HIGH FIDELITY THROUGH HOLE FILM, AND ASSOCIATED METHOD

(76) Inventors: Zhilian Zhou, Chapel Hill, NC (US); Xiansheng Meng, Durham, NC (US); Joseph M. Desimone, Chapel Hill, NC (US); Benjamin Maynor, Durham, NC (US); Jason Rolland, Belmont, MA (US); Kenton B. Wiles, Chapel Hill, NC (US)

(21) Appl. No.: 13/000,244

(22) PCT Filed: Jun. 19, 2009
(86) PCT No.: PCT/US09/47936

§ 371 Date: May 24, 2011

(30) Foreign Application Priority Data
Jun. 24, 2008 (US) 61/075103

(51) Int. Cl. B01D 69/00; B01D 39/00; B01D 71/06; B29C 33/42

(52) U.S. Cl. 210/489; 210/500.21; 210/500.27; 264/316

(57) ABSTRACT

A membrane is provided, comprising a first membrane layer having a first side and a second side. The first membrane layer defines a plurality of holes extending along a first axis between the first side and the second side. Each hole is defined by the first membrane layer as a complex three-dimensional shape, and each hole has a diameter of less than about 10 micrometers. The membrane is fabricated by dispersing a liquid polymeric material onto a patterned master template, hardening the polymeric material, and removing it from the master template. The membrane includes through holes which correspond to the structures of the patterned master template in size, cross-sectional and three dimensional shape, orientation, and the like.

### FEDERALLY SPONSORED RESEARCH OR DEVELOPMENT

This disclosure was partially made with U.S. Government support under contract number N00014-02-1-0185 and N00014-07-1-0269 awarded by the United States Office of Naval Research and under contract number CHE-9876674 awarded by the National Science Foundation. The U.S. Government may have certain rights in the disclosure.

### BACKGROUND

1. Technical Field

Generally, the present disclosure relates to through hole masks and membranes, and more particularly, to membranes defining through holes having precision size and shape characteristics in three dimensions.

2. Description of Related Art

Filters that discriminate based on size and/or shape are well-known. One type of filter, for example, provides a tortuous path through which particles must navigate to pass through the filter. These are sometimes referred to as depth filters, and typically use a filter element made of a thick bed of fiber or other material. Due to their thickness and tortuous path filtration technique, these filters sometimes require relatively high transmembrane (i.e., transfilter) pressures to facilitate flow through or across the filter.

In contrast to depth filters, another well-known type of filter employs a relatively thin filter membrane. These filters, sometimes referred to as membrane filters, typically have micron or submicron pore sizes. Such membranes find application in a wide variety of medical and industrial applications. For example, filter membranes having pore size as low as 0.22 microns have been used to filter bacteria and other matter from liquids such as intravenous solutions. Such microporous filters also have been used to separate the cellular components of human blood (red cells, white cells and platelets) from liquid plasma in which the components are suspended. One well known device for carrying out such separation of blood components is the Autopheresis-C.R™ separator, (Baxter Healthcare Corporation of Deerfield, Ill.).

Although micron and submicron pore size filter membranes have some functionality they generally have limited porosity, discriminate principally on the basis of size alone, and often suffer from reduced flow rates due to blockage on the surface of the membrane. Porosity, as commonly used in the related art, refers to the portion or percentage of the membrane surface that is made up of pores, which can also be referred to as membrane transparency. A high porosity or transparency filter membrane is one in which a large portion of its surface is made up of pores. Such high porosity filter membranes tend to allow higher flow rates through the filter membrane at a given transmembrane pressure than a low porosity or transparency membrane.

More recently, efforts have been directed to developing filter membranes having precise pore sizes and shapes for increased discrimination. Particular efforts have focused at the micron and sub-micron scale for the separation of cells and cell components. Such filters may find application in the separation of blood cells or other types of cells from one another or from liquid in which the cells are suspended.

Filters with micron or smaller scale pores, however, often have significant limitations. One such filter membrane is referred to as a “track-etched” membrane. A track-etched membrane has holes or pores of uniform micron-scale diameter for discrimination based on particle size. However, track-etched membranes typically have low porosity, which limits the amount of throughput and filtration rates. With track-etched filters, for example, porosity tends to be between approximately two and six or seven percent. Attempts to increase porosity in track-etched filter membranes often result in doublets or triplets, which are holes that overlap and therefore reduce the discrimination of the filter membrane. To avoid doublets or triplets, porosity in track-etched membranes is typically limited to about seven percent and less. In addition to low porosity, track-etched membranes have another drawback. The pores in track-etched membranes are limited to circular pores and are therefore not entirely suitable for filtration based on non-circular particle shape or shape alone.

More recently, it has been suggested to use lithographic microfabrication or similar micromachining techniques to provide filter membranes in which the pores have precise size and shape. U.S. Pat. No. 5,651,900 for example, discloses a particle filter made of inorganic material, such as silicon, that is suitable for use in high temperatures and with harsh solvents. The filter has precisely controlled pore sizes formed by interconnecting members and has optional reinforcing ribs.

Precise pore size filter membranes have also been proposed, for example, for separating one class of blood cells from another. U.S. patent application Ser. No. 719,472, entitled “Method and Apparatus for Filtering Suspensions of Medical and Biological Fluids or the Like”, filed Sep. 25, 1996, and hereby incorporated by reference herein in its entirety, describes such filter membranes having precise micron-scale and precision-shaped pores that can be used, for example, to separate red cells from white cells in human blood. Alternative methods for forming filter membranes with precise pore size are described in Gates, Byron D, et. al. “New Approaches to Nanofabrication: Molding, Printing, and Other Techniques” Chem Rev. 2005 April;105(4):1171-96; and Xia, Y., Whitesides, G. M., “Soft Lithography”, Angew. Chem. Int. Ed. 1998, 37, 550-575, each of which are incorporated herein by reference in their entirety.

One drawback, however, is that the manufacture of microstructures such as single-layer filter membranes by microlithography, micromachining, or similar processes suffers from several constraints. Generally, the diameter or largest transverse dimension of the pores can be no smaller than about one-half or one-third the thickness of the membrane itself. Therefore, very small pore sizes, such as one micron or less, require very thin membranes of 2 to 3 microns. The inverse of this is commonly known as the “aspect ratio” and generally means that the thickness can be no more than about 2 or 3 times the pore size. As a result, very thin membranes are typically very fragile and may not be sufficiently robust for many applications.

Many applications require the membrane to be flexible and able to withstand high rotational speeds, shear forces, and transmembrane pressures encountered in many separation systems. A drawback of typical membrane systems is that on the one hand, finer filtration requirements typically demand a filter membrane that is increasingly thin and thus increasingly fragile; however, on the other hand, the desire for membrane robustness has generally been met only by thicker membranes that do not typically permit the formation of high porosity very small precisely controlled pores.

One prior art design directed to membrane fragility includes a filter membrane located on a support layer. U.S. Pat. No. 5,753,014 to Van Rijn, which is incorporated herein by reference in its entirety, describes a membrane having a separate macroporous support structure. Perforations or pores in the membrane layer and in the support structure are made by a micromachining process, such as a lithographic process in combination with etching and an intermediate layer may be deposited between the membrane and support for bonding enhancement and stress reduction. Although such a membrane may be suitable for some applications, it does not overcome limitations of the current art.

Another prior art membrane includes very thin microporous membranes having micron-scale pores, however, these devices are utilized in non-filtration applications. For example, published International Application No. WO 96/10966, published Apr. 18, 1996, which is incorporated herein by reference in its entirety, discloses a microfabricated structure for implantation in host tissue. The structure is composed of a series of membrane layers, each having a different geometric pattern of holes formed by a microfabrication technique. Upon stacking the membranes together, a porous three-dimensional structure is created that purportedly promotes the growth of vascular structures in a host. Yet another prior art membrane that the present disclosure improves upon and/or differentiates over are anodized aluminum oxide membranes, such as Whatman anodisc membranes.

Notwithstanding the current devices, there remains a need for nano and/or micro-porous filter membranes that overcome limitations of the current devices. There also remains a need for new methods and processes for making filter membranes and for apparatus and applications employing such membranes.

### SUMMARY

The above and other needs are met by the present invention which, in one embodiment, provides a membrane. Such a membrane comprises a first membrane layer having a first side and a second side. The first membrane layer defines a plurality of holes extending along a first axis between the first side and the second side. Each hole is defined by the first membrane layer as a complex three-dimensional shape, and each hole has a diameter of less than about 10 micrometers. The complex three dimensional shape of the present membrane can include a cone having an increasing diameter in a direction of flow across the membrane and/or nanometer fidelity features. The holes in the membrane can also be arranged in a predetermine order or spacing. In some embodiments, the plurality of holes includes a density of holes greater than about 80 percent of the first layer. In alternative embodiments, the density of holes includes greater than about 70 percent of the first layer, greater than about 60 percent of the first layer, greater than about 50 percent of the first layer, greater than about 40 percent of the first layer, greater than about 30 percent of the first layer, or greater than about 20 percent of the first layer.

The present disclosure also includes a single or mono-layer membrane where the first layer includes an organic material and a through hole diameter of less than about 1 micrometer or about 500 nanometers. The plurality of holes of the membranes of the present disclosure also include a variety of shapes or sizes such that the membrane can be configured with a gradient of hole shapes or sizes. The membrane can also include a functionalized surface.

The membrane can also include the first membrane layer in combination with a second membrane layer defining a plurality of holes having different size or shape from a size or shape of the plurality of holes of the first membrane layer such that the first membrane layer and second membrane layer are capable of discriminating among different materials to be filtered.

Another aspect of the present invention comprises a method of making a membrane, the method comprising depositing a first polymeric material on a patterned surface of a master template, the patterned surface including structures extending away from a plane formed by the patterned surface, such that the first polymeric material does not extend vertically beyond the structures. Such a method further comprises hardening the polymeric material on the patterned surface of the master template, and removing the hardened polymeric material from the patterned surface of the master template, such that the hardened polymeric material defines a plurality of three dimensionally shaped through holes that correspond to the structures of the master template. The method also includes making a membrane from a fluoropolymer material. The method also includes making the master template a sacrificial master template where removing the hardened polymeric material from the patterned surface of the master template comprises dissolving the master template.

In some embodiments, the method includes, after hardening, depositing a second polymeric material on the hardened polymeric material and hardening the second polymeric material such that the second polymeric material attaches with the hardened polymeric material. In other embodiments, the method includes, after hardening the second polymeric material, applying a force to the hardened second polymeric material to remove the hardened second polymeric material and attached hardened polymeric material from the patterned surface of the master template. In yet further embodiments, the method includes removing the second polymeric material from the hardened polymer material to leave the hardened polymer material as a first membrane layer having holes defined therethrough corresponding to the structures of the master template.

### BRIEF DESCRIPTION OF THE SEVERAL VIEWS OF THE DRAWING(S)

Having thus described the present disclosure in general terms, reference will now be made to the accompanying drawings, which are not necessarily drawn to scale and which do not necessarily illustrate actual geometries, and wherein:

FIG. 1 illustrates a top plan view of a membrane according to an embodiment of the present disclosure;

FIG. 2 illustrates a cross section of a membrane taken in the direction of flow where the membrane includes through holes of different three dimensional shapes according to an embodiment of the present disclosure;

FIG. 3 illustrates a top plan view of a membrane having a density of through holes and a support structure according to an embodiment of the present disclosure;

FIG. 4 illustrates a cross section of a membrane taken in the direction of flow where the membrane includes nanometer structures on its surfaces according to an embodiment of the present disclosure;

FIG. 5 illustrates a process for making a membrane according to an embodiment of the present disclosure;

FIG. 6 illustrates another process for making a membrane according to an embodiment of the present disclosure;

FIGS. 7A-7C illustrate a membrane fabricated according to the present disclosure;

FIGS. 8A-8B illustrate another membrane fabricated according to the present disclosure; and

FIGS. 9A-9B illustrate yet another membrane fabricated according to the present disclosure.

### DETAILED DESCRIPTION

The present disclosure will now be described more fully hereinafter with reference to the accompanying Figures and Examples, in which representative embodiments are shown. The present disclosure describes through-hole masks, filters, and membranes and methods of making and using the same. Generally, the through-hole mask or membrane can be used as a precision pattern mask or for filtration applications. The through-hole masks or membranes of the present disclosure can be configured with a plurality of holes, where each hole has a specifically engineered three dimensional size and shape, and the plurality of holes can have an engineered orientation therebetween and density of holes across the mask or membrane. In some embodiments, the holes on a given through-hole mask or membrane can be highly uniform and in other embodiments the holes can have a gradient or variety of engineered sizes, shapes, orientations, and/or densities. For the remainder of this disclosure the terms through-hole mask, membrane, filter, or the like will be referred to as membrane.

The membranes of the present disclosure can be fabricated from a wide variety of polymers, and the polymers can include a wide variety of physical, chemical, and mechanical properties. The membranes can be fabricated from stiff materials such as, but not limited to, polymers such as polycarbonate or poly(methyl methacrylate), metals, and metal oxides or fabricated from flexible materials such as, but not limited to, polymers and elastomers, such as poly(dimethyl siloxane) or perfluoropolyether.

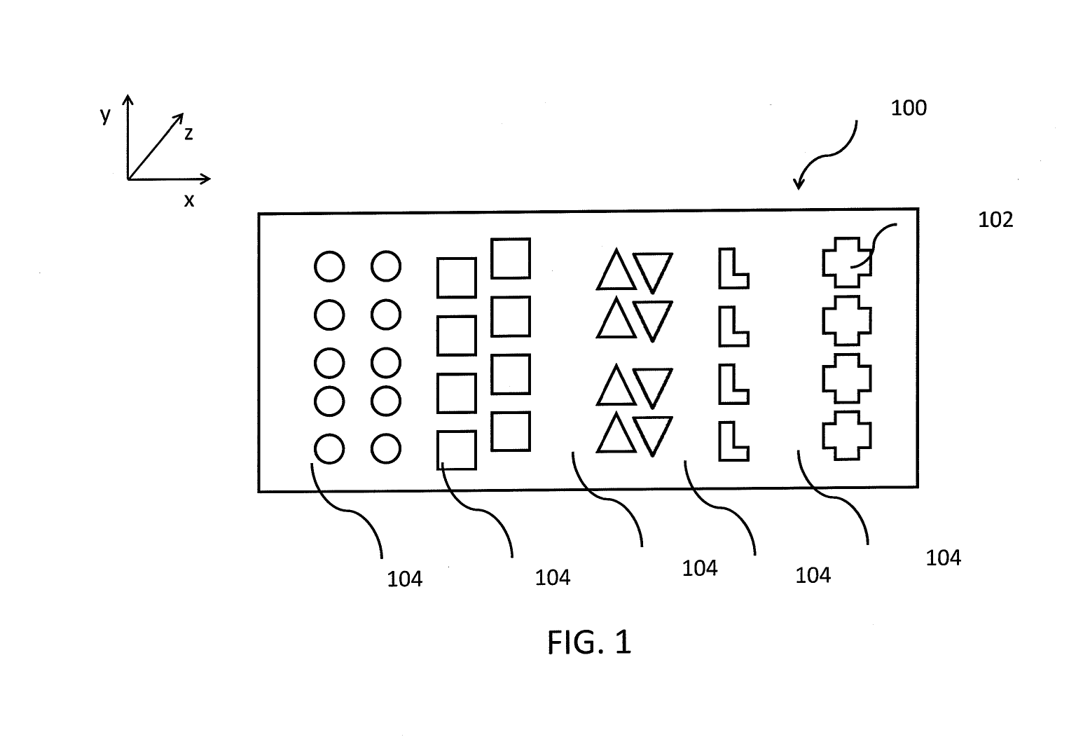

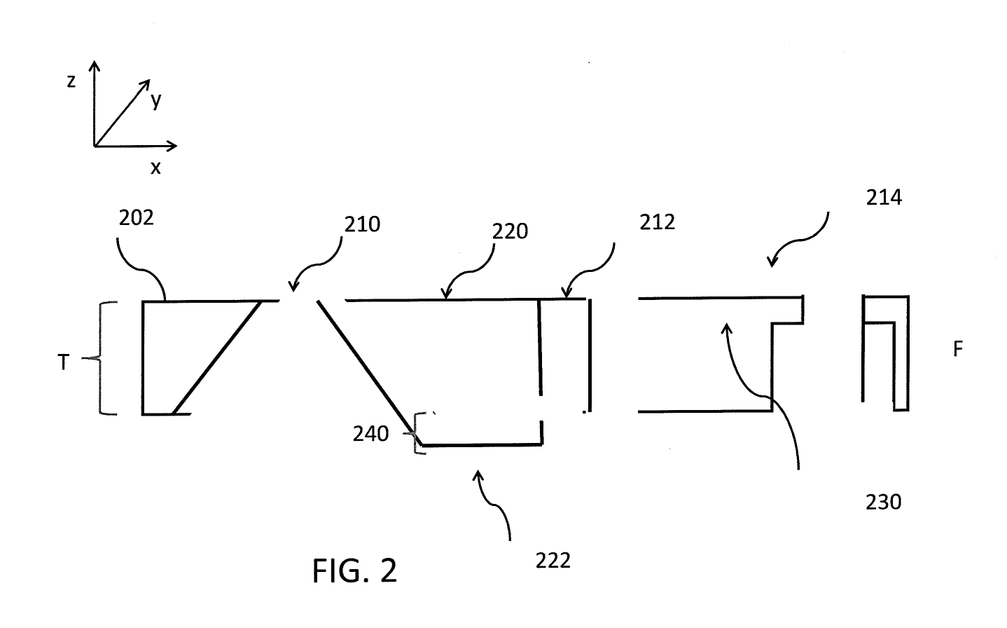

FIG. 1 illustrates a top plan view of a membrane 100, which can be a monolayer membrane 102 defining a plurality of through holes 104 therethrough. Through holes 104 can be configured in a variety of different sizes and shapes and have a variety of spacing between adjacent through holes 104. According to the present disclosure, through holes 104 can be engineered into a wide variety of shapes and sizes in the x-y plane as well as into a wide variety of shapes and sizes in the z-axis direction, as shown in more detail in FIG. 2. In some embodiments, the shape and/or size of through hole 104, in both the x-y plane and/or z-axis direction, can be varied among a given membrane 100 such that a filtration or mask gradient is formed. The methods of the present disclosure allow precision engineering with nanometer fidelity of angles, radius of curvatures, lengths, surface features, combinations thereof, and the like. Furthermore, the spacing between through holes 104, side walls, angles or curvature of through holes 104 and the overall size of membrane 100 can be engineered for a given application. In other embodiments, multiple membranes 100 can be aligned or positioned with respect to each other to form a filtration or separation device that discriminates based on different characteristics at each respective membrane layer.

Referring now to FIG. 2, a monolayer membrane 202 is shown in cross-section showing the z-axis direction, which can be in some embodiments a direction of flow as indicated by arrow F. According to some embodiments, the shape of the through hole in the direction of flow F can be engineered to include complex shapes in cross-section to the direction of flow, such as for example flow direction shapes 210, 212, and/or 214. In some embodiments, flow direction shape can include a generally uniform through hole 212 having generally parallel sides and uniform dimension extending from a first side 220 of membrane 202 to a second side 222 of membrane 202.

Continuing with reference to FIG. 2, complex shapes in the direction of flow can include increasing diameter flow dimension shapes 210 and 214 such that occlusion of the through holes is reduced. Increasing flow dimension shapes 210 and 214 can provide a membrane 202 with a preferred precise hole diameter on a first side 220 of, for example 200 nm diameter, designed for discriminating between materials to be filtered, such as for example sterilization purposes or the like, and increasing to a size on second side 222 larger than the size on first side 220. In some embodiments, the exit side, corresponding to the second side 222 in FIG. 2, can be any size larger than discrimination size of through hole 210 or 214 on first side 220 of membrane 202. In more preferred embodiments, the opening of through hole 210 at second side 222 of membrane 202 can be twice as large as the opening of through hole 210 at first side 220. In still further preferred embodiments, the opening of through hole 210 at second side 222 of membrane 202 can be three times (or more) as large as the opening of through hole 210 at first side 220.

In some embodiments, the increasing diameter can be formed by designing a side or sides of through hole walls to taper away from each other, such as through hole 210. The walls of through hole 210 can taper away uniformly or non-uniformly. In other embodiments, a step or a flange 230, or alternatively multiple steps, can be introduced into the z-axis shape of through hole, such as shown in through hole 214, to yield an increasing diameter of through hole 214 from first side 220 to second side 222 of membrane 202. Flange 230 can have an engineered thickness in the z-axis direction and/or the x-y plane direction to produce a through hole with a particular resistance or acceptance to size variation among particles to be filtered or discriminated amongst. In some embodiments, flange 230 can function as a variable valve. Flange 230 can have a high modulus and therefore provide little or no deflection and passage of particles larger than the opening of the through hole. Likewise, flange 230 can have a low modulus such that flange 230 can be deflected and allow passage of particles larger that the opening of through hole. In other embodiments, a trans-membrane pressure can be applied to membrane 202 to facilitate deflecting flange 230 and allowing passage of particles larger than the opening of through hole 104.

Membrane 202 can also be engineered with a high density of through holes 104. Density of the through holes can be defined as the percentage of membrane 202 surface area that is made up of through holes 104. For example, if 80 percent of the surface area of membrane 202 is occupied by through holes 104, the through hole density of that particular membrane will be about 80 percent. In some embodiments, membrane 202 can have a through hole density of greater than about 90 percent. In some embodiments, membrane 202 can have a through hole density of greater than about 85 percent. In some embodiments, membrane 202 can have a through hole density of greater than about 80 percent. In some embodiments, membrane 202 can have a through hole density of greater than about 75 percent. In some embodiments, membrane 202 can have a through hole density of greater than about 70 percent. In some embodiments, membrane 202 can have a through hole density of greater than about 65 percent. In some embodiments, membrane 202 can have a through hole density of greater than about 60 percent. In some embodiments, membrane 202 can have a through hole density of greater than about 55 percent. In some embodiments, membrane 202 can have a through hole density of greater than about 50 percent. In some embodiments, membrane 202 can have a through hole density of greater than about 45 percent. In some embodiments, membrane 202 can have a through hole density of greater than about 40 percent. In some embodiments, membrane 202 can have a through hole density of greater than about 35 percent. In some embodiments, membrane 202 can have a through hole density of greater than about 30 percent. In some embodiments, membrane 202 can have a through hole density of greater than about 25 percent. In some embodiments, membrane 202 can have a through hole density of greater than about 20 percent. In some embodiments, membrane 202 can have a through hole density of between about 70 percent and about 80 percent. In another embodiment, membrane 202 can have a through hole density of between about 60 percent and about 70 percent. In some embodiments, membrane 202 can have a through hole density that is greater than about 50 percent. In alternative embodiments, membrane 202 can have a through hole density of between about 30 percent and about 70 percent. In still further embodiments, membrane 202 can have a through hole density of between about 40 and about 50 percent. In yet further embodiments, membrane 202 can have a through hole density of between about 30 and about 40 percent. In yet further alternative embodiments, membrane 202 can have a through hole density of greater than about 30 percent. In further embodiments, the membrane 202 can have a through hole density of greater than about 20 percent and less than about 50 percent.

In some embodiments, a membrane includes a first density of pore volume associated with a first side of the membrane and a second density of pore volume associated with a second side of the membrane. In some embodiments, a larger second density of pore volume is associated with larger through hole openings on the second side of the membrane than the corresponding opening size on the first side of the membrane. For example, through holes that taper from an initial size at the first side of the membrane to a larger size at the second side of the membrane results in a membrane having a higher pore volume associated with the second side of the membrane than the pore volume associated with the first side of the membrane.

According to some embodiments, the membrane can be fabricated into a monolayer membrane. In some embodiments, the monolayer can be between about 100 nm to about 1 cm in thickness. In other embodiments, the thickness of membrane 202 can be variable across a given area. As shown in FIG. 2, membrane 202 can include thickness T and also have a different thickness as indicated at region 240 on the same membrane 202.

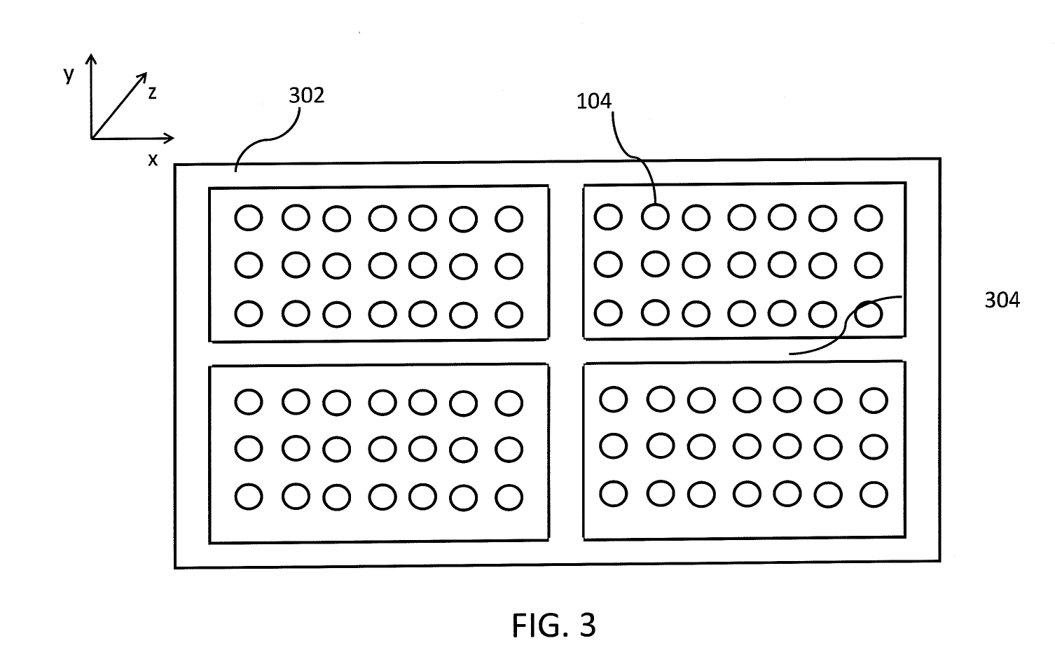

Referring now to FIG. 3, membrane 302, having a density of through holes can be configured with a structural support 304. Structural support 304 can be integral with membrane 302 and fabricated from the same materials as membrane 302 or structural support 304 can be fabricated from a different material than membrane 302 and coupled together with membrane 302. In some embodiments, structural support 304 is integral with membrane 302 and formed in the same step as forming through holes 104 (described herein). Structural support 304 can add mechanical strength to membrane 302 or be tuned to provide physical or mechanical characteristics needed in particular applications of membrane 302. Furthermore, in high through hole density applications, structural support 304 can reinforce membrane 302. In alternative embodiments, the placement, thickness, pattern, or the like of structural support 304 can be altered to provide the physical or mechanical support and/or tailored for particular applications.

The material that the membrane can be fabricated from can be selected to yield a membrane with a desired modulus. For example, the membrane of the present disclosure can be fabricated to have a modulus of between about 1 MPa and about 200 GPa. In other embodiments, the membrane has a modulus of between about 1 MPa and about 100 GPa. In other embodiments, the membrane has a modulus of between about 1 MPa and about 50 GPa. In other embodiments, the membrane has a modulus of between about 10 GPa and about 50 GPa. In other embodiments, the membrane has a modulus of between about 25 MPa and about 75 MPa. In other embodiments, the membrane has a modulus of between about 25 MPa and about 50 MPa. In other embodiments, the membrane has a modulus of between about 10 MPa and about 50 MPa. In other embodiments, the membrane has a modulus of between about 50 MPa and about 100 MPa. In other embodiments, the membrane has a modulus of between about 1 MPa and about 25 MPa. In other embodiments, the membrane has a modulus of between about 1 MPa and about 10 MPa. In other embodiments, the membrane has a modulus of less than about 100 MPa. In other embodiments, the membrane has a modulus of less than about 75 MPa. In other embodiments, the membrane has a modulus of less than about 50 MPa. In other embodiments, the membrane has a modulus of less than about 25 MPa. In other embodiments, the membrane has a modulus of less than about 10 MPa. In other embodiments, the membrane has a modulus of less than about 5 MPa. In other embodiments, the membrane has a modulus of less than about 1 MPa. The membrane of the present disclosure can be flexible and contour to a non-planar surface or structure. A non-planar membrane can increase the surface area or otherwise increase or effect the efficiency of the membrane.

According to some embodiments, the size of the through hole, as measured by the broadest dimension in the x-y plane can be less than about 5 micrometers. In some embodiments, size of a through hole measured at its broadest linear dimension in the x-y plane can be less than about 2 micrometers. In some embodiments, size of a through hole measured at its broadest linear dimension in the x-y plane can be less than about 1 micrometer. In some embodiments, size of a through hole measured at its broadest linear dimension in the x-y plane can be less than about 750 nanometers. In some embodiments, size of a through hole measured at its broadest linear dimension in the x-y plane can be less than about 500 nanometers. In some embodiments, size of a through hole measured at its broadest linear dimension in the x-y plane can be less than about 250 nanometers. In some embodiments, size of a through hole measured at its broadest linear dimension in the x-y plane can be less than about 200 nanometers. In some embodiments, size of a through hole measured at its broadest linear dimension in the x-y plane can be less than about 100 nanometers. In some embodiments, size of a through hole measured at its broadest linear dimension in the x-y plane can be less than about 75 nanometers. In some embodiments, size of a through hole measured at its broadest linear dimension in the x-y plane can be less than about 50 nanometers. In some embodiments, size of a through hole measured at its broadest linear dimension in the x-y plane can be less than about 25 nanometers. In some embodiments, size of a through hole measured at its broadest linear dimension in the x-y plane can be less than about 10 nanometers.

In some embodiments, the membrane forms a through hole having a predetermined cross-sectional shape in the x-y plane. In some embodiments, the cross-sectional shape in the x-y plane can include, but is not limited to, a predetermined angle between two sides, two parallel sides, two non-parallel sides, a radius of curvature, combinations thereof, or the like. According to some embodiments, the through hole can be fabricated to have a cross-sectional shape in the x-y plane that includes, but is not limited to, a circle, a triangle, a square, a rectangle, a hexagon, an octagon, a polygon, a parallelogram, a diamond, a crescent, a virus, a cell, a red blood cell, a protein, combinations thereof, or the like. In some embodiments, the through hole of a membrane can be fabricated to match desired natural or man-made shapes and or patterns.

The through hole includes a complex three dimensional shape in the z-axis direction defined by walls extending through the membrane in the z-axis direction. In some embodiments, the through hole has a constant cross section along the z-axis between the first and the second side of the membrane and thereby defines a through hole with parallel walls. In some embodiments, the membrane forms a through hole having a predetermined cylindrical shape in the z-axis direction. In some embodiments, the membrane defines a through hole having predetermined non-parallel walls extending through the membrane in the z-axis direction. In some embodiments, the membrane defines a through hole having a wall with a predetermined radius of curvature extending through the membrane in the z-axis direction.

In some embodiments, the membrane defines a through hole having a complex three-dimensional shape. A through hole having a complex three-dimensional shape may have a cross-section in the x-y plane or z-axis direction that varies in size and/or shape. In some embodiments, a through hole having a complex three-dimensional shape is defined by a channel having predetermined non-parallel walls. In some embodiments, a through hole having a complex three-dimensional shape is defined by a channel wherein the channel walls are tapered at a predetermined angle toward each other. In some embodiments, a through hole having a complex three-dimensional shape is defined by a channel wherein the channel walls are tapered at a predetermined angle away from each other. In some embodiments, a through hole having a complex three-dimensional shape includes a non-circular cross section. In some embodiments, a through hole having a complex three-dimensional shape includes an increasing or decreasing cross sectional diameter along an axis from a first side to a second side of the layer defining the through hole, thereby forming for example, a cone-shaped hole.

In some embodiments, the membrane defines through holes which are shaped and/or positioned in a predetermined manner to control flow of a substance over and/or through the membrane. In some embodiments, the through holes are shaped in order to enhance flow of a substance through the holes and/or to reduce clogging. In some embodiments, the through holes are cone-shaped and thereby reduce clogging of a substance which flows through the hole from a smaller end to a larger end.

The through holes of the membranes of the present disclosure include high uniformity in size and/or shape. In such embodiments, the through holes have a normalized size distribution of between about 0.80 and about 1.20, between about 0.90 and about 1.10, between about 0.95 and about 1.05, between about 0.99 and about 1.01, or between about 0.999 and about 1.001, combinations thereof, or the like. Furthermore, in some embodiments the through holes defined in the membrane are mono-disperse. In some embodiments, the dispersity is based on, for example, surface area, length, width, height, mass, volume, porosity, combinations thereof, and the like.

In some embodiments, the membrane defines through holes in a predetermined array wherein the spacing between each through hole is substantially uniform and includes a predetermined spacing. In some embodiments, the membrane defines through holes in a predetermined array wherein the spacing between each through hole is substantially non-uniform but includes a predetermined spacing.

According to yet other embodiments, a surface of the membrane or the surface of the through hole defined in the membrane can be functionalized. The functionalizing of a surface of the membrane can include an agent selected from the group including enzymes, dyes, fluorescent tags, radiolabeled tags, biorecognition agents, contrast agents, ligands, catalytic reagents, peptides, pharmaceutical agents, proteins, hydrophilic compounds, hydrophobic compounds, ionic compounds, compounds and materials disclosed elsewhere herein, combinations thereof, and the like. This functionalization introduces the ability to selectively pass substances, bind substances, react with substances, or otherwise interact with substances being introduced or passed through the membrane. Interactions include enzymatic, covalent binding, ionic bonding, other intra- and inter-molecular forces, hydrogen bonding, van der Waals forces, combinations thereof, and the like. In this manner one could encourage specific substances to pass through the membranes while impeding others, tag specific substances, analyze the substances trapped on the membrane, determine when the membrane is at capacity, catalyze reactions, or capture substances, for example. In some embodiments, the membrane includes a charge on a surface that is different than a charge in the pore.

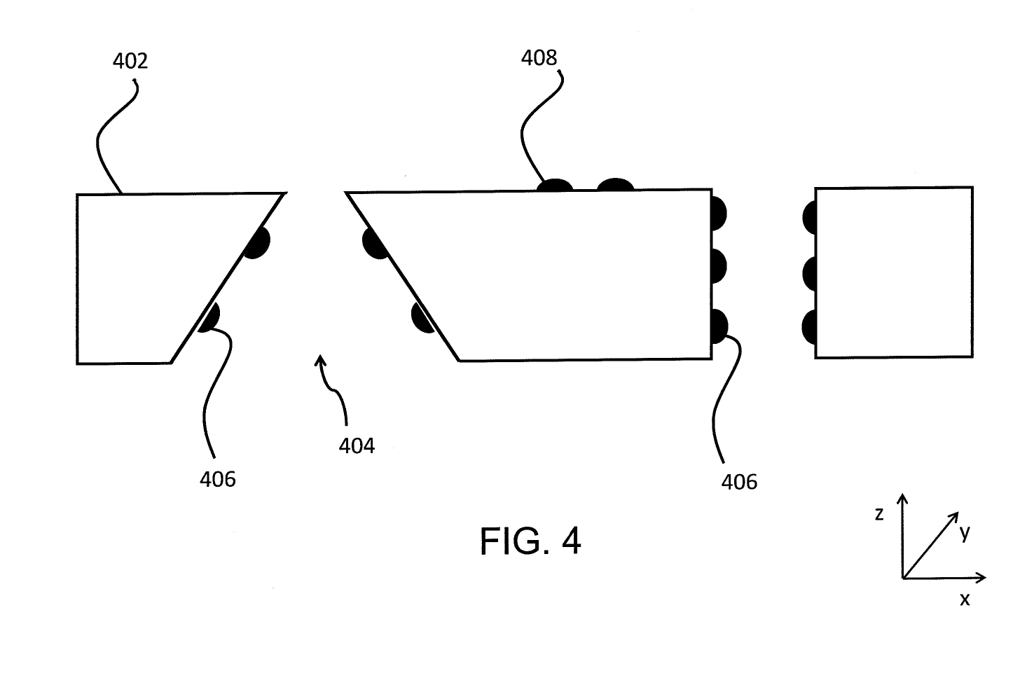

Referring now to FIG. 4, high fidelity complex structures 408, 406 can be fabricated on the surface of membrane 402 or on the walls of the through holes defined in membrane 402. High fidelity complex structures 406, 408 can include a variety of shapes or characteristics with nano-fidelity including a predetermined angle, parallel sides, non-parallel sides, radius of curvature, combinations thereof, and the like with nano precision. The complex structures 406, 408 can form a variety of precision three-dimensional structures protruding from the membrane 402. The nano-fidelity of complex structures 406, 408 can include precision within 10 nanometers. In other embodiments, the nano-fidelity of complex structures 406, 408 can include precision within about 5 nanometers. In some embodiments, the nano-fidelity of complex structures 406, 408 can include precision within about 2 nanometers. In still further embodiments, the nano-fidelity of complex structures 406, 408 can include precision within about 1 nanometer.

As shown in FIG. 4, membrane 402 can include a through hole 404 having complex structure 406 configured on a wall of through hole 404. Complex structures 406 can increase the surface area of through hole 404, create a torturous path for substances being filtered, cause substances being filtered to rotate, adjust, or align in a selected manner, tailor the shape or size of through hole 404 with nano-fidelity, capture selected substances, react with substances, combinations thereof, or the like. Membrane 402 can also have complex structures 408 configured on a surface that is not a wall of through hole 404. Complex structures 408 can increase the surface area of membrane 402, prevent blockage of the through holes 404 by not allowing large substances to actually contact through hole 406 opening, reduce adhesion of a substance to be filtered to membrane 402 by reducing surface contact area between a substance introduced to membrane 402 and the surface of membrane 402, cause turbulent flow around holes 404, combinations thereof, and the like.

In some embodiments, the membrane of the present disclosure can be fabricated from a wide variety of polymeric materials and can have wide variety of mechanical, physical, and chemical properties that can be tailored for particular applications. In some embodiments, the membrane can be fabricated from chemically inert materials such as a fluorinated material (i.e., perfluoropolyether), materials with a desired modulus to conform to a surface, degradable materials selected to degrade for a particular purpose, biodegradable materials, combinations thereof, and the like. In some embodiments, the membrane can be fabricated from thermoplastics, thermosets including elastomers, sol-gels, and uv-curable resins, or the like. In other embodiments, the membrane can be fabricated from polymeric materials, including but not limited to, poly(ethylene glycol diacrylate), poly(ethylene glycol monoacrylate) with disulfide crosslinks, poly(dimethyl siloxane), poly(arylene ether sulfone), 35 mole % disulfonated poly(arylene ether sulfone), poly(trimethylolpropane triacrylate), polycarbonate, poly(methyl methacrylate, polystyrene, poly (tetrafluoroethylene), poly (fluorinated ethylene-propylene), and the like. In other embodiments, the membranes can be fabricated from biologic materials into biologic material membranes, protein materials into protein membranes, lipids into lipid membranes, biomemitic lipids into biomemitic lipid membranes, polysaccharides into polysaccharide membranes, DNA into DNA membranes, RNA into RNA membranes, combinations thereof, and the like. In other embodiments, the membranes can be fabricated from shape-memory polymer materials. In some embodiments, shape-memory polymer materials can be materials composed of two components with different thermal characteristics, such as for example, oligo(ε-caprolactone)diol and crystallisable oligo(ρ-dioxanone)diol.

In some embodiments, the membrane can be applied as a coating to a device, such as but not limited to a medical device, a diagnostic instrument or device, a sensor, a tissue, an organ, combinations thereof, or the like. Including the membrane as a coating on a device can, in some embodiments, protect the device from interacting with unintended substances that cannot pass through the pores of the membrane, assist in selectively presenting substances of interest to a device, combinations thereof, or the like.

In some embodiments, the membrane can be fabricated from a material that are etch resistant, have a low modulus, have a high modulus, have a low surface energy, have a high surface energy, are temperature stable, are chemically stable, combinations thereof, and the like.

In alternative embodiments, the membrane material can be fabricated from a low surface energy polymeric material, such as but not limited to a fluoropolymer, perfluoropolyether, or FLUOROCUR® (Liquidia Technologies, Inc.). According to such embodiments, the low surface energy characteristic of the membrane materials provides low adhesion and interaction between a substance to be filtered and the membrane, thereby, for example providing a low fouling membrane. According to other embodiments, current membranes fabricated from fluoropolymer or perfluoropolyether materials are highly chemically resistant and can provide low fouling, high tolerance membranes. According to some embodiments, the materials for the membranes of the present disclosure include materials with a surface energy of less than 15 mN/m. According to other embodiments, the materials for the membranes of the present disclosure include materials with a surface energy of less than about 12 mN/m. According to still further embodiments, the materials for the membranes of the present disclosure include materials with a surface energy of less than about 10 mN/m.

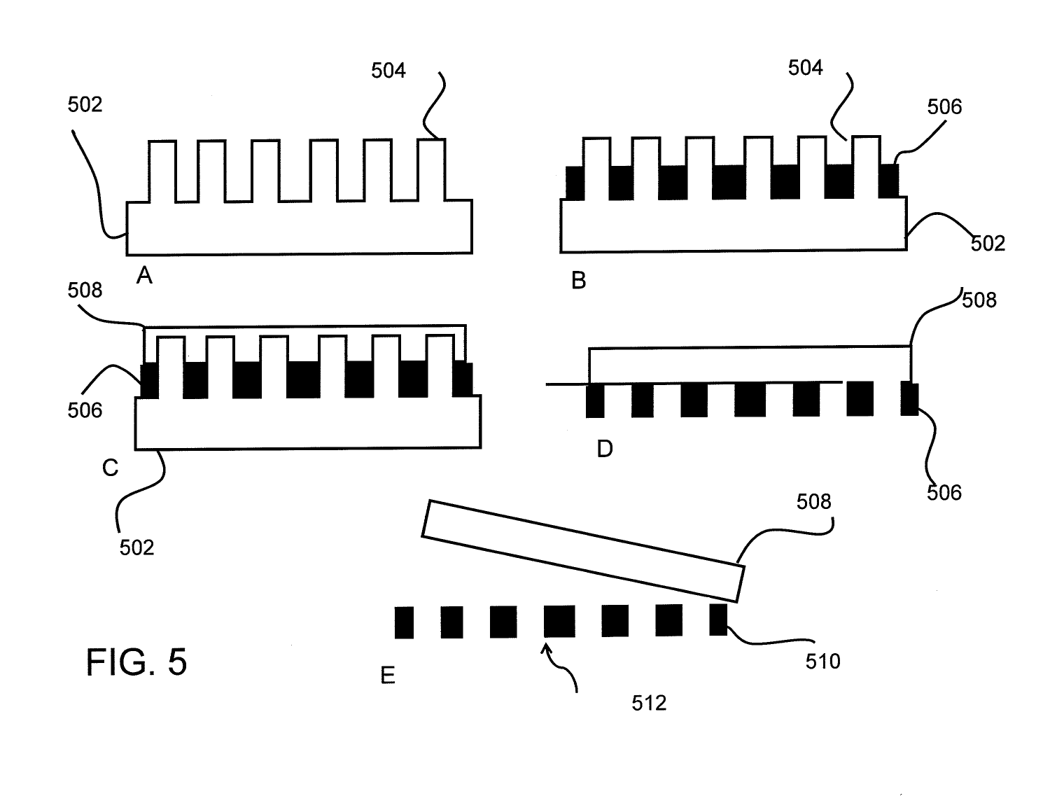

The membrane of the present disclosure may be generally fabricated using techniques of pattern replication in non-wetting templates. According to one embodiment and as shown in FIG. 5, a method for making a membrane may initially begin with a master template 502, such as for example a silicon master or the like, as shown in step A. Master 502 may include structures 504 that are engineered into master 502 by typical lithographic techniques, etching techniques, or the like to form a pattern. Structure 504 can be any shape, size, density, combinations thereof, and the like that can be fabricated into master 502. Next, as shown in step B, a polymeric material 506 may be introduced onto the patterned side of master 502. Polymeric material 506 may be introduced such that it does not exceed or extend beyond the height of structure 504 extending from master 502. Polymeric material 506 may then be cured or otherwise hardened. Following hardening of polymeric material 506, a second polymeric material 508 may be introduced onto hardened polymeric material 506 and, if second polymeric material 508 is liquid it is cured or hardened, as shown in step C. Second polymeric material 508 may adhere, bind with, or have an affinity for hardened polymeric material 506 such that when second polymeric material 508 is removed from master 502, hardened polymeric materials 506 is also removed from master 502, as shown in step D. Next, hardened polymeric material 506 may be removed from second polymeric material 508, thereby resulting in a membrane 510 having through holes 512 that mirror size, shape, and arrangement of structures 504, as shown in step E. According to some embodiments, second polymeric material 508 can be selected from, but not limited to PET, acrylates, cyanoacrylates, poly(vinyl pyrrolodinone), carbohydrates, arabinogalactin, lactose, water soluble polymers, FLUOROCUR® (Liquidia Technologies), combinations thereof, and the like.

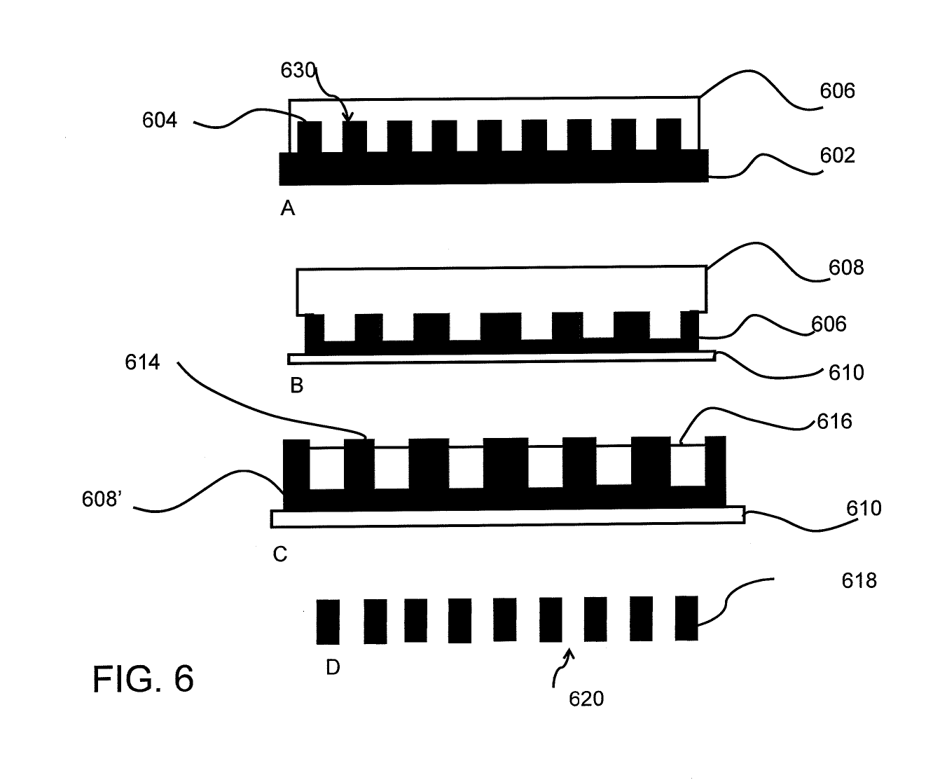

Referring now to FIG. 6, a method for fabricating a membrane according to the present disclosure may include replicating a master template 602 with first polymeric material 606, as shown in step A. Master 602, similar to master 502, may be fabricated according to known techniques in the art and may be fabricated to include precision engineered structures 604. First polymeric material 606 used to replicate master 602 preferably may retain substantially the same volume in a liquid phase as a solid phase such that when cured or hardened it replicates structures 604 with nano-fidelity. First polymeric material 606 also preferably may have a low surface energy such that it does not bind or otherwise adhere to master 602 or other materials that come into contact with. In some embodiments, first polymeric material 606 can be selected from the group of, but not limited to, fluoropolymer, perfluoropolyether, FLUOROCUR® (Liquidia Technologies, Inc, Durham, N.C,), or the like.

Next, as shown in step B, second polymeric material 608 may be introduced into the patterned side of hardened first polymeric material 606. In some embodiments, second polymeric material 608 may be sandwiched between hardened first polymeric material 606 and a substrate 610. Following applying second polymeric material 608 to hardened first polymeric material 606, second polymeric material 608 may be hardened or cured to thereby replicate structures 604 replicated in hardened first polymeric material 606. Second polymeric material 608 can be selected from the group of, but is not limited to, water soluble polymers, such as poly(ethylene glycol), poly (vinyl pyrrolidinone, poly(acrylic acid), poly(vinyl alcohol), or poly (styrene sulfonic acid) and organic-soluble polymers such as cyanoacrylate and polystyrene. After hardening second polymeric material 608, hardened first polymeric material 606 may be removed and hardened second polymeric material 608 can be used as a sacrificial master 608′, as shown in step C. Sacrificial master 608′ may include structures 614 that are replicas of structures 604 in master 602. Next, as shown in step C of FIG. 6, membrane material 616 may be introduced onto sacrificial master 608′. In some preferred embodiments, structures 614 may not be fully submersed in membrane material 616, thereby extending completely through membrane material 616 added to sacrificial master 608′. Membrane material 616 may then be cured or otherwise hardened. Next, hardened membrane material 616 may removed from sacrificial master 608′ to yield membrane 618 having through holes 620 that mimic structures 604 in master 602, as shown in step D. In some embodiments hardened membrane material 616 may be removed from sacrificial master 608′ by physically removing the hardened membrane materials 616. In other embodiments, after membrane material 616 is hardened but while still in contact with sacrificial master 608′, the combination may be introduced into an environment that selectively degrades or dissolves or otherwise removes sacrificial master 608′, thereby leaving membrane 618.

In other embodiments, the depth of wells 630 defined between adjacent structures 604 can be varied. To obtain variable thickness in membrane 202 a master from which membrane is molded may be configured with varying depths between structures cut, etched, or molded into master. Therefore, when a membrane is molded from master 602 or replicate 606 or 608′, made from master 602, the membrane may have a varying thickness corresponding to the depth of respective wells 630 and an amount of membrane material 616 (such as varying thickness 240 shown in FIG. 2).

Membranes of the present disclosure may be used for a variety of applications. Precise control over the size, shape, and density of the membranes' holes allows for improvements in various fields of use, such as but not limited to, through hole masks, deposition masks, metal deposition mask, photomask, gravimetric and density analysis, filtration devices, sterilization filtration, biosensors, monitoring, precise size and/or shape separation devices, cascade impactor, optics such as beam shaping, transmission filters, beam splitter, photonic beam gap devices, or the like. Membranes of the present disclosure can also provide gradient masks or filters where the size, shape, arrangement, and/or combinations thereof on a given membrane are selectively varied across the membrane to provide gradient masking or gradient filtration. In further embodiments, multiple monolayer membranes with the same size, shape, arrangement, or a variety of sizes, shapes, and/or arrangements can be coupled together or spaced apart to provide further separation or discrimination of a sample.

According to other embodiments, the through-hole masks of the present disclosure can be used as shadow masks and can be used as precision patterning tools in many applications. The mask functions to provide a designed or engineered pattern in the form of the through holes and protective coverage (non-through hole area) over a substrate for a variety of processes, including vapor deposition of metals and other materials, beam projection, ion implantation through the openings, and the like. The masks of the present disclosure can also be used as shadow masks in patterning of electrical and optical elements in displays. They can be particularly useful in organic light emitting diode (OLED) flat panel displays. In manufacturing OLED displays, a shadow mask is used to pattern the electroluminescent coatings onto the substrate.

In another application of the present disclosure the membrane can be used as a shadow mask for solder bump placement during flip-chip fabrication. Solder bumps need to be placed on each of the devices at the wafer level and bonded to another wafer later. This requires highly precise placement of high precision bumps, which can be accomplished by the membranes of the present disclosure. A specific example of this application is the use of shadow masks to deposit low melting point indium on irradiation detector chips.

Material selection for the membrane of the present disclosure is determined by particular application for the membrane and associated parameters. For example, membranes used for metal deposition often fail due to metal build-up, therefore, a non-stick low surface energy membrane would be helpful. Furthermore, another parameter of importance is the coefficient of thermal expansion and the stability of the membrane itself. In many applications it is important to have low coefficient of thermal expansion to reduce any dimensional change due to heat absorbed from metal vapor during deposition. Membranes of the present disclosure fabricated from fluoropolymers, perfluoropolyether, or FLUOROCUR® (Liquidia Technologies, Inc., Durham, N.C.) provide membranes with substantially stable coefficient of thermal expansion between the temperature range of about 50 degrees Celsius to about 300 degrees Celsius.

Manufacturing membranes according to the present disclosure provides the advantages of rapid and inexpensive fabrication, capabilities for making large area masks, and capabilities to use a variety of materials to tailor the property of mask material. The ability to make the through holes with controlled shape and size also provides the possibility to target more application fields. A flexible through mask should also find unique application in deposition and irradiation/projection processes, as well as patterning curved surfaces.

Subject matter disclosed in the following referenced patents, patent applications, and publications is useful in and with the membranes of the present disclosure, the references including: U.S. Pat. Nos. 3,303,085; 3,713,921; 3,852,134; 4,652,412; 6,861,358; 6,878,208; 7,001,501; U.S. patent applications U.S.2003/0098121; U.S.2005/0263452; U.S. 2005/0276791; U.S. patent application Ser. No. 719,472, entitled “Method and Apparatus for Filtering Suspensions of Medical and Biological Fluids or the Like”, filed Sep. 25, 1996; PCT international patent applications WO90/07545; WO99/22843; WO99/54786; WO05/033685; WO06/072784; and publications Multiscale Patterning of Plasmonic Metalmaterials, Henzie, J. et.al., Nature Nanotechnology v.2, September 2007 at www.nature.com/naturenanotechnology; and Membranes & Microfluidics: A Review, de Jong; J, et. al., Lab Chip, 2006, 6, 1125-1139 at www.rsc.org/loc; each of which are hereby incorporated by reference herein in their entirety.

Each reference identified herein is hereby incorporated by reference as if set forth in its entirety.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

### Example 1

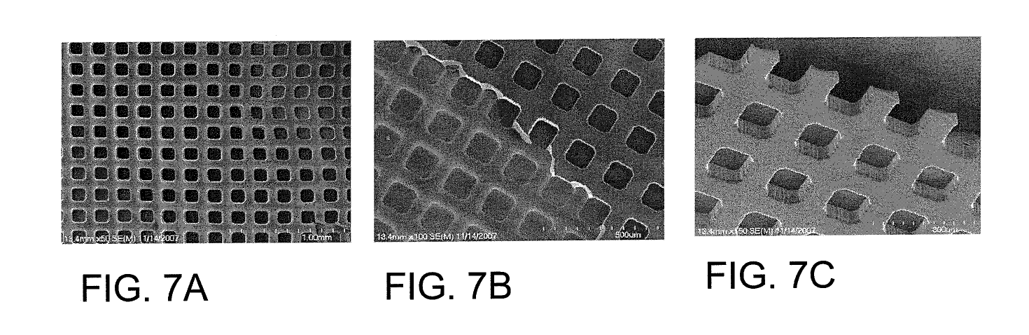

An SU-8 photo-resist (PR) master with 110 um (length) by 110 um (width) by 50 um (height) features were used to make Fluorocur® (FCR) through membranes. A 50% solution of FLUOROCUR® (Liquidia Technologies, Inc., Durham, N.C.) resin with 0.1% 2,2-diethoxyacetophenone (DEAP) as photo-initiator in solkane (1,1,1,3,3-pentafluorobutane) was spin coated onto the PR master at 500 rpm for 1 min. The concentration of the solution and spin rate were controlled so that the resulting FCR layer is lower than the feature height of the PR master. Solkane evaporated during spin-coating. The thin layer of FCR on PR master was cured by 365 nm UV light for 2 min without nitrogen flow followed by 3 min with nitrogen purge. To help release the cured FCR through-hole membrane, a layer of norland optical adhesive (NOA) was laminated between the FCR membrane and PET substrate. After curing NOA74 by exposing to 365 nm UV for 4 min with nitrogen purge, the FCR through-hole membrane was removed from the PR master and then separated mechanically from the NOA74 backing layer. The SEM images shown in FIGS. 7a and 7b show the FCR through-hole membrane before and after separating from the NOA74-PET backing layer. The cut end of the membrane in FIG. 7b confirms that the holes in FCR membrane are through-holes.

### Example 2

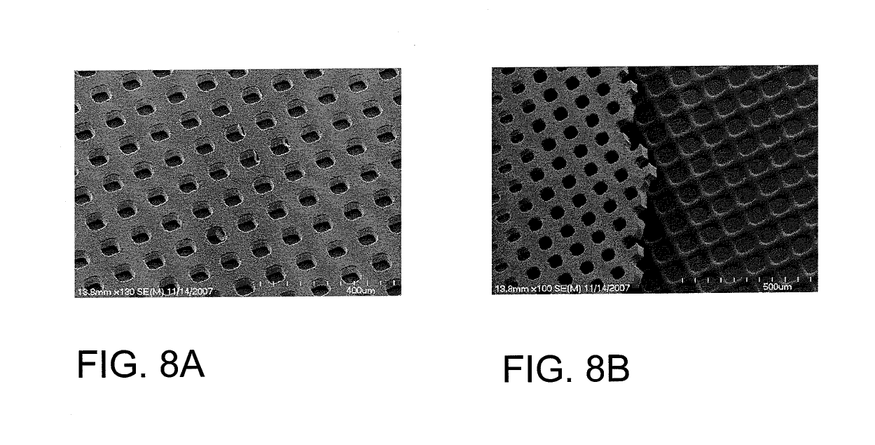

A photo-resist (PR) master with 50 um (length) by 50 um (width) by 65 um (height) features were used to make Fluorocur® (FCR) through membranes. A 50% solution of FLUOROCUR® (Liquidia Technologies, Inc., Durham, N.C.) with 0.1% 2,2-diethoxyacetophenone (DEAP) as photo-initiator in 1,1,1,3,3-pentafluorobutane (solkane) was spin coated onto the PR master at 500 rpm for 1 min. The concentration of the solution and spin rate were controlled so that the resulting FCR layer is lower than the feature height of the PR master. Solkane evaporated during spin-coating. The thin layer of FCR on PV master was cured by 365 nm UV light for 2 min without nitrogen flow and 3 min with nitrogen purge. To help release the cured FCR through-hole membrane, a layer of norland optical adhesive (NOA) was laminated between the FCR membrane and PET substrate. After curing NOA74 by exposing to 365 nm UV light for 4 min with nitrogen purge, the FCR through-hole membrane was removed from the PR master and then separate from the NOA74 backing layer mechanically. SEM images, shown in FIGS. 8a and 8b show the FCR through-hole membrane before and after separating from the NOA74-PET backing layer. The shallow patterned feature in the NOA74 layer shown in FIG. 8b confirms that the holes in the FCR membrane are through-holes.

### Example 3

A regular FCR mold was first prepared from the 110 um (length) by 110 um (width) by 50 um (height) SU-8 photoresist (PR) master. This FCR mold was used to make a NOA74 submaster. To do so, NOA74 was laminated between flat glass and the FCR mold and cured by 365 nm UV light for 4 minutes with nitrogen purge. The NOA74 submaster was obtained after removal of the FCR mold. This submaster was then used to make through hole membranes. A 50% solution of FLUOROCUR® (Liquidia Technologies, Inc., Durham, N.C.) with 0.1% 2,2-diethoxyacetophenone (DEAP) as photo-initiator in 1,1,1,3,3-pentafluorobutane (solkane) was spin coated onto the sub-master at 500 rpm for 1 min. The concentration of the solution and spin rate were controlled so that the resulting FCR layer is lower than the feature height of the sub-master. Solkane evaporated during spin-coating. The thin layer of FCR on PV master was cured by 365 nm UV light for 2 min without nitrogen flow and 3 min with nitrogen purge. The cured FCR through-hole membrane was then carefully removed from the submaster by a tweezers.

### Example 4

A regular FCR mold was first prepared from the 110 um (length) by 110 um (width) by 50 um (height) SU-8 photoresist (PR) master. This FCR mold was used to make a cyano-acrylate submaster. To do so, cyano-acrylate was laminated between a glass plate and the FCR mold and cured by leaving at atmosphere for 14 hr. The cyano-acrylate submaster was obtained after removal of the FCR mold. This submaster was then used to make through-hole membranes. A 50% solution of FLUOROCUR® (Liquidia Technologies, Inc., Durham, N.C.) with 0.1% 2,2-diethoxyacetophenone (DEAP) as photo-initiator in solkane (1,1,1,3,3-pentafluorobutane) was spin coated onto the sub-master at 500 rpm for 1 min. The concentration of the solution and spin rate were controlled so that the resulting FCR layer is lower than the feature height of the sub-master. Solkane evaporated during spin-coating. The thin layer of FCR on sub-master was cured by 365 nm UV light for 2 min without nitrogen flow and 3 min with nitrogen purge. The cured FCR through-hole membrane on the submaster was then soaked in acetone. As cyano-acrylate dissolved in acetone, the FCR through-hole membrane was released and was rinsed and dried.

### Example 5

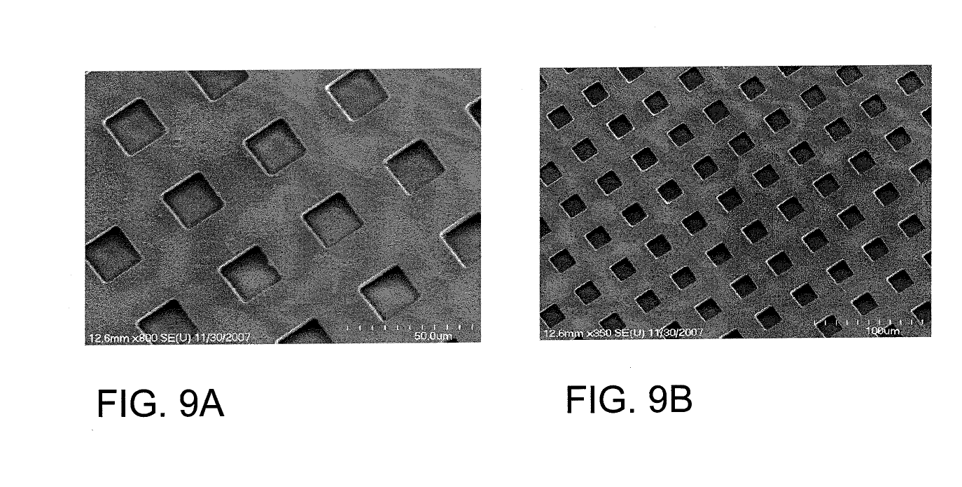

A regular FCR mold was first prepared from a 20 um (length) by 20 um (width) by 20 um (height) PR master. This FCR mold was used to make a cyano-acrylate submaster. To do so, cyano-acrylate was laminated between a glass plate and FCR mold and cured by leaving at atmosphere for 14 hr. The cyano-acrylate submaster was obtained after removal of the FCR mold. This submaster was then used to make through-hole membranes. A 30% solution of FLUOROCUR® (Liquidia Technologies, Inc., Durham, N.C.) with 0.1% 2,2-diethoxyacetophenone (DEAP) as photo-initiator in solkane(1,1,1,3,3-pentafluorobutane) was spin coated onto the sub-master at 500 rpm for 1 min. The concentration of the solution and spin rate were controlled so that the resulting FCR layer is lower than the feature height of the sub-master. Solkane evaporated during spin-coating. The thin layer of FCR on the sub-master was cured by 365 nm UV light for 2min without nitrogen flow and 3 min with nitrogen purge. The cured FCR through-hole membrane on the submaster was then soaked in acetone. As cyano-acrylate dissolved in acetone, the FCR through-hole membrane was released and dried afterwards. FIGS. 9a and 9b shows the SEM images of the FCR through hole membrane of this example.

### Example 6

A regular FCR mold was first prepared from the 110 um (length) by 110 um(width) by 50 um (height) SU-8 photoresist (PR) master. This FCR mold was used to make a cyano-acrylate submaster. To do so, cyano-acrylate was laminated between glass and FCR mold and cured by leaving at atmosphere for 14 hr. The cyano-acrylate submaster was obtained after removing the FCR mold. This submaster was then used to make through-hole membranes. A 50% solution of NOA74 in acetone was spin coated onto the sub-master at 500 rpm for 1 min. The concentration of the solution and spin rate were controlled so that the resulting NOA74 layer is lower than the feature height of the sub-master. Acetone evaporated during spin-coating. The thin layer of NOA74 on sub-master was cured by 365 nm UV light for 4 min with nitrogen purge. The cured NOA74 through-hole membrane on the submaster was then soaked in acetone. As cyano-acrylate dissolved in acetone, the NOA74 through-hole membrane was released and dried afterwards.

### Example 7

Shape specific silicon master templates were fabricated using e-beam lithography. Molds of the master templates were first generated using Norland Optical Adhesive 7 (Norland Products Inc.) that were cured using UV radiation. The molds were removed and checked for fidelity using scanning electron microscopy (Hitachi 4700 SEM operating at 1 kV). PFPE-diacrylate was pooled over the mold and placed in a UV radiation chamber. The chamber was allowed to purge with nitrogen for 10 minutes to remove oxygen. The PFPE-diacrylate material was cured to form an exact replica of the silicon master template. PFPE molds were investigated for proper fidelity using SEM.

Film fabrication was performed using the PFPE molds containing various shape and size specific characteristics—5 μm, 3 μm and 160 nm rectangular pores and shape specific pores of 3 μm arrows and 800×200×100 nm bars. A PFPE-diacrylate substrate was fabricated on a glass slide following the previously discussed curing technique. The PFPE substrate was removed from the glass and used as the base for the membrane mold. Pools of liquid monomer/polymer material of choice (poly(ethylene glycol dimethacrylate), poly(ethylene glycol monomethacrylate) with disulfide crosslinks, poly(dimethyl siloxane), poly(arylene ether sulfone), 35 mole % disulfonated poly(arylene ether sulfone) and poly(trimethylolpropane triacrylate)) were placed on the PFPE substrate in a controlled manner. The PFPE mold containing the silicon master template characteristics was placed on top and allowed to wet the monomer/polymer liquid material. The stacked substrate-liquid-mold was placed in a clear or metal pressure jack and placed in a UV radiation curing oven or convection oven. The monomer/polymer material was either cured using UV radiation (triacrylate resin, PEG) or heat (Sylgard 184), or was molded using evaporative heating (poly(arylene ether sulfone)). After proper fabrication of the micro- or nanoporous membrane, the mold was removed from the substrate. The film was removed from the mold using polyvinyl alcohol (PVA) adhesive. This process involved placing drops of 24 wt % PVA on a glass substrate and placing the mold containing the film on top. Pressure was applied to the mold to wet the glass and film. The stack of glass-PVA solution-film-PFPE mold was placed on a hot plate at 80° C. to allow the water to evaporate from the PVA solution. After 7 hrs, the PFPE mold was removed from the PVA-glass substrate, thereby leaving the porous film adhesively bonded to the PVA. Microscopy characterization of the films was carried out using optical and electron microscopy techniques. For transmission electron microscopy (CM12 Phillips TEM operating at 100 kV) and membrane stacking, the films were removed from the PVA adhesive using a water bath and collected using TEM grids or fine mesh screens.

What is claimed is:

1. A membrane, comprising:
a first membrane layer having a first side and a second side, the first membrane layer defining a plurality of holes extending along a first axis between the first side and the second side, each hole being defined by the first membrane layer as a complex three-dimensional shape, and each hole having a diameter of less than about 10 micrometers.

2. The membrane of claim 1, wherein the complex three dimensional shape comprises a cone having an increasing diameter in a direction of flow across the first membrane layer.

3. The membrane of claim 1, wherein the complex three dimensional shape comprises nanometer fidelity.

4. The membrane of claim 1, wherein the holes are arranged in a predetermine order.

5. The membrane of claim 1, wherein the plurality of holes comprises a density of holes greater than about 80 percent of the first membrane layer.

6. The membrane of claim 1, wherein the plurality of holes comprises a density of holes greater than about 70 percent of the first membrane layer.

7. The membrane of claim 1, wherein the plurality of holes comprises a density of holes greater than about 60 percent of the first membrane layer.

8. The membrane of claim 1, wherein the plurality of holes comprises a density of holes greater than about 50 percent of the first membrane layer.

9. The membrane of claim 1, wherein the plurality of holes comprises a density of holes greater than about 40 percent of the first membrane layer.

10. The membrane of claim 1, wherein the plurality of holes comprises a density of holes greater than about 30 percent of the first membrane layer.

11. The membrane of claim 1, wherein the plurality of holes comprises a density of holes greater than about 20 percent of the first membrane layer.

12. The membrane of claim 1, wherein a plurality of holes on the first side comprises a first density of holes and a plurality of holes on the second side comprises a second density of holes different than the first density of holes.

13. The membrane of claim 1, wherein the first membrane layer comprises an organic material and the diameter comprises a diameter less than about 1 micrometer.

14. The membrane of claim 1, wherein the first membrane layer comprises an organic material and the diameter comprises a diameter less than about 500 nanometers.

15. The membrane of claim 1, wherein the plurality of holes comprises at least one of a plurality of shapes and sizes such that the membrane is configured with a gradient of at least one of hole shapes and sizes.

16. The membrane of claim 1, wherein the first membrane layer further comprises a functionalized surface.

17. The membrane of claim 1, further comprising a structure configured on the first membrane layer.

18. The membrane of claim 1, further comprising the first membrane layer in combination with a second membrane layer defining a plurality of holes having at least one of a different size and shape from at least one of a size and shape of the plurality of holes of the first membrane layer such that the first membrane layer and second membrane layer are capable of discriminating among different materials to be filtered.

19. A method of making a membrane, comprising:
depositing a first polymeric material on a patterned surface of a master template, the patterned surface including structures extending away from a plane formed by the patterned surface, such that the first polymeric material does not extend vertically beyond the structures;
hardening the polymeric material on the patterned surface of the master template; and
removing the hardened polymeric material from the patterned surface of the master template, such that the hardened polymeric material defines a plurality of three dimensionally shaped through holes that correspond to the structures of the master template.

20. The method of claim 19, wherein depositing a first polymeric material on a patterned surface of a master template further comprises depositing a polymeric material comprising a fluoropolymer.

21. The method of claim 19, wherein depositing a first polymeric material on a patterned surface of a master template further comprise depositing a first polymeric material on a patterned surface of a master template comprising a sacrificial master template.

22. The method of claim 21, wherein removing the hardened polymeric material from the patterned surface of the master template further comprises dissolving the master template.

23. The method of claim 19, further comprising depositing a second polymeric material on the hardened polymeric material and hardening the second polymeric material such that the second polymeric material is operably engaged with the hardened polymeric material.

24. The method of claim 23, further comprising applying a force to the hardened second polymeric material to remove the hardened second polymeric material and attached hardened polymeric material from the patterned surface of the master template.

25. The method of claim 24, further comprising removing the second polymeric material from the hardened polymer material to leave the hardened polymer material as a first membrane layer having holes defined therethrough corresponding to the structures of the master template.
